(19) United States
(12) Patent Application Publication
(10) Pub. No.: US 2003/0009606 A1
(43) Pub. Date: Jan. 9, 2003

(54) Future generation software platform

(76) Inventor: Santhanagopalan Muthukannan, Fremont, CA (US)

Correspondence Address: SANTHANAGOPALAN MUTHUKANNAN, 184 BEAR COURT, FREMONT, CA, 94539, US

(21) Appl. No.: 10/190,857

(22) Filed: Jul. 6, 2002

Related U.S. Application Data
(60) Provisional application No. 60/303,227, filed on Jul. 6, 2001.

(51) Int. Cl. G06F 9/00

(52) U.S. Cl. 709/328

(57) ABSTRACT

The rapid expansion of Internet technology and global business environment has set demands for newer and faster software applications enabling B2B commerce and information exchange. This invention provides a single extendible software framework with a complete development environment for front office applications, a rich set of back office components and a powerful middle tier transaction platform. This future generation software platform allows the enterprise and Internet applications to be developed and deployed in a rapid manner. The platform is light and portable and based on thin client and thin server model. It is a unique solution that offers high performance and scalability with a rich set of extendible features. The platform presents a clear solution to present day's hardware and software constraints.

### CROSS-REFERENCE TO RELATED APPLICATIONS

I claim the benefit of an earlier provisional patent application No. 60/303,227 with title ‘Future Generation Software Platform FugenSP’ dated Jul. 6, 2001.

### STATEMENT REGARDING FEDERALLY SPONSORED RESEARCH OR DEVELOPMENT

Not Applicable

### BACKGROUND OF THE INVENTION

The invention relates to the field of enterprise software applications and particularly to the development, deployment, data management and real time sharing of information using the software at a global level.

The rapid expansion of Internet technology and global business environment has set demands for newer and faster software applications for enabling B2B commerce and information exchange for the coming years. The demand for software that is scalable, adaptable, and extendible with a longer life cycle is very high and is imperative to minimize the total cost of ownership (TCO).

In today's information age, computers and software have become an integral part of almost any organization specially at the core level. Even as dependency on software continues to increase, organizations are less inclined to invest in software applications since high software costs affect the net profits. This has become one of the major barriers for organizations eager to expand and be a global competitor in their core business.

Added to that, the current e-business software environment does not scale even to the present needs, not to mention future needs of the marketplace. Conventional business software applications are primarily based on client-server computing model. To make it robust and usable the typical software application is an integration of several components such as middleware, security, networking, and business logic to name a few. Unfortunately, the process of development and integration requires software and domain experts from several areas. Further, organizations often face unavailability of proper talent and technology. This process is time consuming, eating away at precious “time to market” which increases real and hidden costs and results in lost revenues and lower profits.

Most of these software are platform dependent, prohibiting the customer from adopting newer and better hardware and infrastructure. In order to alleviate this problem, the vendors are forced to develop and maintain different versions for various operating systems and hardware, often resulting in huge capital expenditure and in-house maintenance costs. The integration of these software modules involves additional levels of complexity, as it requires experts from several other areas resulting in more expenses. Unfortunately, the cost is passed to the customer at the end.

Even the large corporations with extensive B2B and B2C activity are finding it difficult to change applications often. The financial implications of repeated user training and unfamiliarity with new software, negatively impacts businesses and eats into an already eroded margin.

Today's applications often have to be modified to be Internet ready to be accessible from outside of an enterprise, creating a huge barrier in the availability of information. Most of the applications are bulky, wrap around, non-user friendly, platform specific and require mega servers to house and deploy. These issues have created a barrier for the Service Providers to host applications on the Internet as the cost of infrastructure has become exorbitant.

In short, today's software applications take a long time to develop and deploy. They are expensive and do not scale. The TCO including software purchase price, customization, improvement, maintenance and upgrades is very high and is not consistent with the associated benefits.

### BRIEF SUMMARY OF THE INVENTION

This invention provides a single extendible software framework with a complete development environment for front office applications, a rich set of back office components and a powerful middle tier transaction platform.

This future generation software platform allows the enterprise and Internet applications to be developed and deployed in a rapid manner. Although, the platform has been developed using Java as the base computer language, the framework used in the platform is programming language independent.

This invention provides a solution to the deficiencies existing in the software application market. Further, the platform provides clear economic advantages to the end user by saving significant amount of time, material and resources in areas including software development, implementation, integration and usage.

All of the above is achieved with a size less than a Mega byte making it an extremely light and portable software platform. This invention also allows the service providers to flourish by offering highly scalable and available solutions at a fraction of the cost of the major players. The possibility of software development in weeks instead of months opens the doors for newer types of services to be offered on the Web. This enables service providers and enterprises to offer newer and faster applications that are current.

Advantages

1) Low Application Development Cost

This platform has a rich set of APIs for developers to use facilitating the rapid development of applications with less manpower and resources.

2) Light and Portable

This platform is extremely small in size allowing it to be portable and easily deployable eliminating large hardware costs.

3) Platform Independent Applications

The platform has been developed in Java to work on all Java enabled operating systems. This allows the organizations to develop applications to be platform independent and conform to open standards.

4) Rapid Development, Test and Launch

The platform with its rich framework allows applications to be developed, tested and launched in a short span of time. Developers can plug and play their logic rules easily with the platform.

5) Flexible, Manageable and Extendible

The platform allows the client applications to extend its functionality and clients can allow their applications to be extended for future enhancements.

6) Rapid Integration

The platform's open framework results in a smooth integration with existing systems.

7) Security, Performance, and Reliability

The platform provides a secure transaction medium utilizing the latest security standards. The small size code and robust framework provides high performance capability in all tiers and a reliable system.

8) Flexible Deployment Options

Applications developed using this platform have several deployment options saving organizations significant money and resources.

9) Cut Maintenance Costs

The platform does not require heavy infrastructure in terms of networking and computing hardware. The flexible deployment options and highly automated features of the platform provide significant cost savings in maintenance.

### BRIEF DESCRIPTION OF THE SEVERAL VIEWS OF THE DRAWING

Not Applicable

### DETAILED DESCRIPTION OF THE INVENTION

This invention provides a single extendible software framework with a complete development environment for front office applications, a rich set of back office components and a powerful middle tier transaction platform. This future generation software platform allows the enterprise and Internet applications to be developed and deployed in a rapid manner.

The platform provides several key components that are necessary for an enterprise or Internet software application. The components include application server, transactional server, middleware, network, security, user management and communication. Further, the platform has several other modules to assist in software development, deployment and implementation. The robust framework provides tight integration and at the same time offers the total flexibility to extend its rich functionality. By providing the components as reusable objects the platform allows applications to use them multiple times, without redundant coding, by invoking the components. This also minimizes the necessity of integrating with third party components saving significant amount of money and resources.

The platform has hundreds of open Application Programming Interfaces (API). The APIs are key assets for developers to rapidly design, develop, and release applications that are light, reliable, and extendible for enterprises, Internet, or mobile markets. The framework also allows the developers to extend the platform's functionalities to provide enhanced features as part of their software. This provides a unique opportunity for software resellers and integrators to jumpstart their development efforts saving significant amount of time and resources.

The Graphical user interface APIs of the platform offers a rich set of features for the developers to quickly develop user interfaces that are contemporary. Its plug and play approach allows the business logic rules to be easily deployed at the server level. Its powerful middleware and networking components allows the seamless connections between the client and server modules. The platform's distributed computing model allows it to connect with databases spread across the world. These features allow the developers to reuse the platform for various types of software modules without having to integrate additional middleware and server components and mix and match databases.

The platform's open architecture using industry standards such as XML, results in smooth integration with existing systems. It offers high level of security with features such as digital signatures, encryption of data, access control and database authentication.

The platform has been developed in Java to work on all Java enabled operating systems. The use of the platform allows organizations to develop applications that are platform independent and conform to open standards. Although, the platform has been developed using Java as the base computer language, the framework is programming language independent.

The platform allows applications to be hosted both in the Enterprise and Service Provider (SP) environment. With its lightweight characteristics, the platform provides an opportunity for organizations to host several of their e-business software in a single hardware server. This by itself is a significant shift from the present day paradigm of having several hardware servers to host a single software application, creating a positive economic impact.

With key component offerings, the platform provides organizations with total software management capabilities to administer their software with very little effort. The administration could be performed from a central location or from multiple locations.

The platform is extremely thin and portable with a size of less than one Mega byte. This invention also allows the software development companies and service providers to flourish by offering highly scalable and available solutions at a fraction of the cost of the major players. The possibility of software development in weeks instead of months opens the doors for newer types of services to be offered on the Web.

This invention provides a solution to the deficiencies existing in the application software market. Further, the platform provides clear economic advantages to the end user by saving significant amount of time, material and resources in areas including software development, implementation, integration and usage.

What I claim is:

1. A plug and play, thin client and thin server model for development and deployment of software applications for Internet and enterprises.

2. A platform to distribute, connect and replicate servers and databases at a global level in real time.

3. A software infrastructure platform consisting of reusable business components and open Application Programming Interfaces to develop software applications.

4. A single extendible software framework with a complete development environment for front office applications, a rich set of back office components and a powerful middle tier transaction platform.
